(19) United States
(12) Patent Application Publication
(10) Pub. No.: US 2009/0265451 A1
(43) Pub. Date: Oct. 22, 2009

(54) ASSISTED APPLICATION DEFINITION

(75) Inventors: Katrin SHECHTMAN, Ramat Gan (IL); Vittaly Tavor, Ramat Hasharon (IL); Alexander Gilenson, Givatayim (IL); Amihai Hadar, Herzliya (IL); Yaniv Menuhin, Rishon LeZion (IL)

Correspondence Address: SUGHRUE MION, PLLC, 2100 PENNSYLVANIA AVENUE, N.W., SUITE 800, WASHINGTON, DC, 20037, US

(73) Assignee: E.S.I. SOFTWARE LTD., Park Afek (IL)

(21) Appl. No.: 12/426,052

(22) Filed: Apr. 17, 2009

Related U.S. Application Data
(60) Provisional application No. 61/124,727, filed on Apr. 17, 2008.

(51) Int. Cl. G06F 15/177

(52) U.S. Cl. 709/221

(57) ABSTRACT

A system and a method for characterizing an application the method including one or more of monitoring installation of an application and recording information relating to one or more file system, registry and database resources created or modified during installation of the application, monitoring an application run and recording information relating to one or more file system, registry, database and network resources accessed during run of the application and manually entering information relating to one or more file system, registry, database and network resources employed by the application and filtering the information to provide filtered information and classifying the filtered information to obtain classified information.

### REFERENCE TO RELATED APPLICATIONS

Reference is hereby made to U.S. Provisional Patent Application 61/124,727 filed Apr. 17, 2008 and entitled ASSISTED APPLICATION DEFINITION, the disclosure of which is hereby incorporated by reference and priority of which is hereby claimed pursuant to 37 CFR 1.78 (a)(4) and (5)(i).

### FIELD OF THE INVENTION

The present invention relates to configuration management in complex computerized environments.

### BACKGROUND OF THE INVENTION

The following publication believed to be relevant to the present invention: U.S. Pat. No. 5,418,941.

### SUMMARY OF THE INVENTION

The present invention seeks to provide methods and systems for defining a configuration of an application for subsequent monitoring in complex computerized environments.

There is thus provided in accordance with a preferred embodiment of the present invention a system for characterizing an application in a way that enables gathering of application configuration information.

The system includes one or more of application installation monitoring functionality operative to monitor installation of an application and record information relating to one or more file system, registry and database resources created or modified during installation of the application, application run monitoring functionality operative to monitor an application run and record information relating to one or more of file system, registry, database and network resources accessed during run of the application, and manual information input functionality operative to enable manual entering of information relating to at least file system, registry, database and network resources employed by the application, information filtering functionality operative to provide filtered information and classification functionality operative to classify the filtered information into one or more groups based on criticality and/or significance.

There is additionally provided, in accordance with a preferred embodiment of the present invention, a method for characterizing an application in a way that enables gathering of application configuration information.

The method includes one or more monitoring installation of an application and recording information relating to one or more file system, registry and database resources created or modified during installation of the application, monitoring an application run and recording information relating to one or more file system, registry, database and network resources accessed during run of the application and manually entering information relating to one or more file system, registry, database and network resources employed by the application and filtering the information to provide filtered information and classifying the filtered information to obtain classified information.

Preferably, the method also includes grouping the information into two or more of the following categories: signature or bill of materials (BOM), configuration information, runtime information and instance parameters.

More preferably, the classifying also includes classifying the filtered information into one or more the following classifications based on significance: installation specific significance, performance significance, localization significance, security significance, recovery significance, high availability significance, application startup-ability significance and functional significance.

Yet more preferably, one or more the monitoring an application run, manually entering, filtering and classifying is repeated at least once.

Even more preferably, the monitoring an application run and recording information also includes recording information relating to one or more file system, registry and database resources created or modified during run of the application.

Most preferably, the method includes generating application configuration definitions based on one or more the filtered information and on classification thereof.

In accordance with a preferred embodiment of the present invention, the method also includes one or more distributing the application configuration definitions to one or more agents, collecting application configuration information from the one or more agents based on the application configuration definitions, noting changes in the application configuration information defined by the application configuration definitions, classifying the changes into one or more groups based on criticality and significance in accordance with the application configuration definitions and acting based on the changes and the classification in accordance with the application configuration definitions.

Preferably, the acting includes one or more sending an E-mail, registering user alerts in an event log and/or a system log and sending a text message.

More preferably, the filtering includes employing user definable custom filters to filter the information and/or automatically filtering the information in accordance with the application configuration definitions.

Even more preferably, the method also includes formatting future information presentation using the classified information.

Most preferably, the classifying includes associating with each item of the filtered information a descriptor identifying a manner in which the item affects the application.

In accordance with a preferred embodiment of the present invention, the information includes information relating to configuration items having greater granularity than resources. Additionally, the classifying filtered information also includes referencing configuration items having greater granularity than resources.

Preferably, the classifying also includes classifying the filtered information based on criticality and/or classifying the filtered information into one or more groups based on significance. Additionally, classifying also includes classifying the filtered information as to the extent and/or type of a result produced by a change in a given configuration item irrespective of a granularity of the given configuration item.

In accordance with a preferred embodiment of the present invention, the method also includes one or more initiating monitoring installation of an application to begin recording information relating to one or more file system, registry and database resources created or modified during installation of the application, launching and carrying out the installation of the application, monitoring the installation of the application and recording the information relating to resources created or modified during installation of the application and terminating the monitoring the installation and recording.

Subsequently, in accordance with a preferred embodiment of the present invention, initiating monitoring an application run to begin recording information relating to one or more file system, registry, database and network resources accessed during run of the application, launching and carrying out the application run, monitoring the application run to begin recording the information relating to resources accessed during the run of the application, terminating the monitoring the application run and recording.

Subsequently and preferably, manually entering information relating to one or more file system, registry, database and network resources which information has not been recorded, filtering the information to provide filtered information and classifying the filtered information into one or more groups based on criticality and/or significance.

### BRIEF DESCRIPTION OF THE DRAWINGS

The present invention will be understood more fully from the following detailed description in which:

FIG. 1 is a simplified block diagram illustrating a system constructed and operative in accordance with an embodiment of the present invention, in a complex computerized environment;

FIG. 2 is a simplified flowchart of the invention generally illustrating the methodology of the present invention; and

FIG. 3 is a simplified flowchart illustrating a preferred implementation of application definition generation methodology in accordance with the present invention.

### DETAILED DESCRIPTION OF A PREFERRED EMBODIMENT

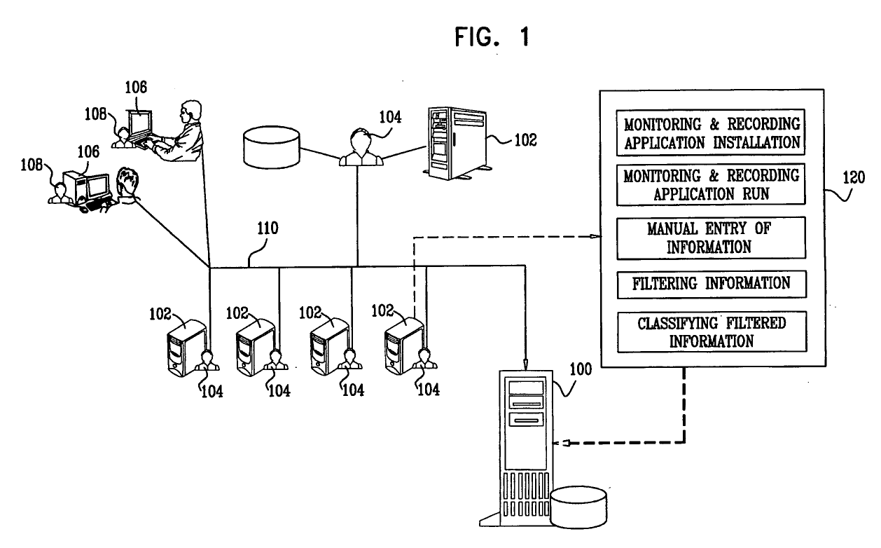

Reference is now made to FIG. 1, which is a simplified block diagram illustration of a preferred embodiment of the system of the present invention in a complex computerized environment. As seen in FIG. 1, a configuration management server 100 monitors and manages the configuration of a plurality of servers 102 in a complex computerized environment via a corresponding plurality of agents 104 associated with respective servers 102. The configuration management server 100 is able to format or present information collected thereby and/or by agents 104.

Servers 102 communicate with a multiplicity of client computers 106, some of which may have agents 108 associated therewith. Communication between servers 102, client computers 106, agents 104 and 108 and configuration management server 100 preferably takes place along a bus 110.

It is a particular feature of the present invention that application definition outputs are provided by an application definition assistant 120 which is capable of characterizing an application, which application may run on any one or more of servers 102, in a way that enables gathering of application configuration information by agents 104 and/or 108, so as to enable identification and classification of future configuration changes. The functionality of application definition assistant 120 preferably includes:

at least one of the following:
monitoring installation of an application and recording information relating to at least file system, registry and database resources created or modified during installation of the application;
monitoring an application run and recording information relating to at least file system, registry, database and network resources accessed during the run of the application; and
enabling manual entry of information relating to at least file system, registry, database and network resources employed by the application; and

filtering the information recorded during installation monitoring and/or during application run monitoring and classifying filtered information based on criticality and into one or more groups based on significance.

The information which is recorded by the application configuration assistant may be grouped under the following categories:
Signature or Bill Of Materials (BOM): Resources that are monitored for changes by tracking parameters such as last access time, checksum, version number and other external information;
Configuration Information: Configuration information items having greater granularity than resources. For example, reference may be made to specific parameters in an XML file rather than to the entire file or to specific contents of a database table rather than to the table in its entirety. Such items may also include, for example, an indication of configuration values which remain unchanged even when their order within a file has changed.
Runtime Information: Changes occurring in resources from one application invocation to another, which changes may not be classified as critical changes and/or significant changes, but the information, as such, may be of value to the user. Such information items may include, for example, an application process ID or a list of the application open communication ports.
Instance Parameters: Information relating to resources that are unique to a specific installation instance but change with every additional installation instance. Such parameters may include, for example, the instance name of a database server or of an application installation folder, which may change with each new application installation.

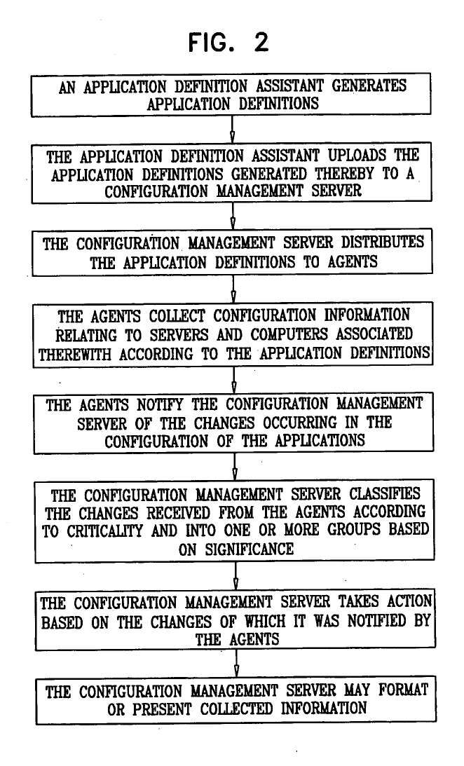

Reference is now made to FIG. 2, which is a simplified flowchart of the invention, generally illustrating operation of the methodology of the invention. As seen in FIG. 2, an application definition assistant, such as application definition assistant 120 shown in FIG. 1, generates application definitions, which are subsequently uploaded to a configuration management server, such as configuration management server 100 of FIG. 1. As will be described in greater detail hereinbelow, the application definition assistant, operating off-line, monitors installation of an application and records information relating to at least file system, registry and database resources created or modified during the installation of the application. During this off-line monitoring and recording operation, the application definition assistant may reside on one or more servers such as servers 102 of FIG. 1, or on a separate server.

The following functions are also provided by the application definition assistant when it operates off line, thereby generating application definitions:
filtering the information recorded during monitoring the installation and monitoring an application run; and
classifying filtered information based on criticality and into one or more groups based on significance.

The application definitions are subsequently uploaded to the configuration management server, which distributes the application definitions to agents, such as agents 104 and/or 108 of FIG. 1. The Agents collect configuration information relating to servers and computers corresponding thereto based on the application definitions.

Turning to FIG. 2, it is seen that the agents notify the configuration management server of changes in the configuration of the applications defined by the application definitions.

The configuration management server classifies the changes of which it is notified by the agents based on criticality and into one or more groups, in accordance with the application definitions provided by the application definition assistant. The configuration management server takes various actions based on the changes of which it was notified by the agents. These actions may include sending an E-mail, registering user alerts in event or system logs, sending a text message (SMS) and other types of alerts based on the changes and on their criticality and group classification as indicated by the application definitions supplied by the application definition assistant. Additionally and preferably, the configuration management server may format or present collected information.

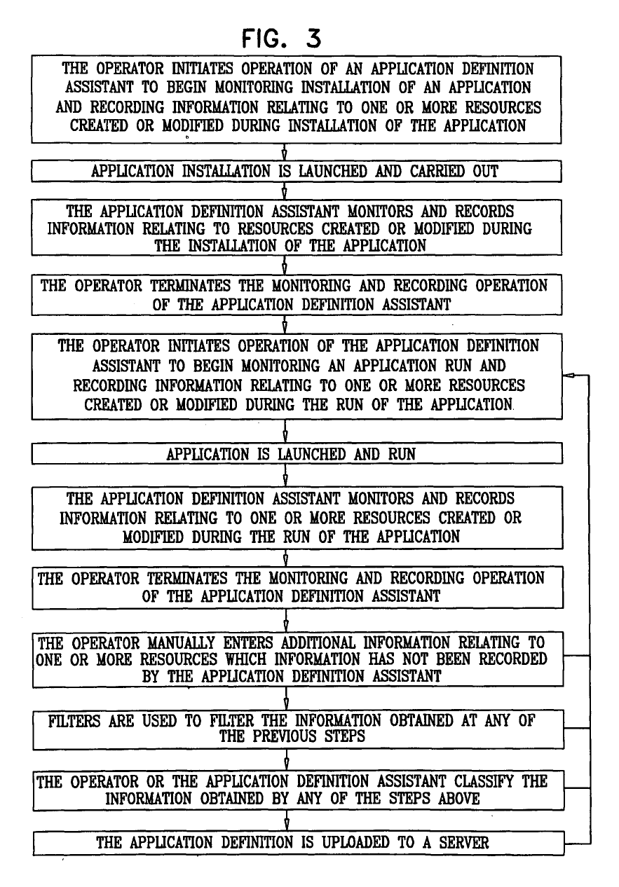

Reference is made to FIG. 3, which is a simplified flowchart illustrating a preferred implementation of application definition generation methodology of the present invention. As noted above, the functionality of FIG. 3 is preferably carried out off-line.

A. Initially, an operator, who is typically responsible for configuration management, initiates operation of an application definition assistant, such as application definition assistant 120 of FIG. 1, to begin monitoring installation of an application and recording information relating to at least file system, registry and database resources created or modified during installation of the application. Application installation is subsequently launched and carried out, while the application definition assistant monitors and records information relating to such resources which are created or modified during installation of the application. Thereafter the operator terminates the monitoring and recording operation of the application definition assistant.

B. Subsequently, the operator initiates operation of the application definition assistant to begin monitoring an application run and recording information relating to at least file system, registry, database and network resources accessed during run of the application. The application is subsequently launched and run, thereby accessing at least file system, registry, database and network resources, while the application definition assistant monitors and records information relating to such resources which are created or modified during run of the application. Thereafter, the operator terminates the monitoring and recording operation of the application definition assistant.

C. Thereafter, the operator may manually enter additional relevant information relating to at least file system, registry, database and network resources which have not been recorded by the application definition assistant.

It will be appreciated that any one or more of steps A, B and C listed above may be obviated.

D. Information relating to at least file system, registry, database and network resources, obtained by any of steps A, B and C, is preferably filtered automatically by filters defined and operated by the application definition assistant. Additionally or alternatively, the operator may manually add more filter rules to filter out some of the information obtained by any of steps A, B and C

E. The filtered information is preferably classified by the application definition assistant according to its relative criticality to application configuration, such as by associating with each remaining information item a descriptor which identifies a manner in which the item affects the application. Additionally or alternatively, the filtered information may also be classified by the application definition assistant into one or more groups based on their significance as to application configuration. Such groups may include:

An Installation Specific Significance Group;

A Performance Significance Group;

A Localization Significance Group;

A Security Significance Group;

A Recovery Significance Group;

A High Availability Significance Group;

A Application Start Up-ability Significance Group; and

A Functional Significance Group.

Additionally or alternatively, the operator may manually add more criticality definitions or rules to classify some of the information according to its relative criticality and significance group to application configuration.

Steps B, C, D and E may be repeated several times, based on system considerations.

It is appreciated that the information obtained by any one or more of steps A, B and C, may additionally be related to configuration items having greater granularity than resources. For example, reference may be made to specific parameters in an XML file rather than to the entire file or to specific contents of a database table rather than to the table in its entirety.

Thus, the classification in step E, may reference configuration items having greater granularity than resources.

The classification in step E may relate not only to criticality and group classification based on significance, but also to the extent and type of result produced by a change in a given configuration item, irrespective of its granularity. For example, a change in a specific parameter, such as a parameter indicating the database cache size, may affect the performance of the database. A change in database collation may affect application localization behavior. Following application definition generation as described hereinabove with reference to FIG. 2, the application definitions may be uploaded to a server such as server 100 (FIG. 1).

It will be appreciated by persons skilled in the art that the present invention is not limited to what has been particularly shown and described hereinabove. Rather, the scope of the invention includes both combinations and sub-combinations of various features described hereinabove as well as modifications and variations thereof which would occur to a person skilled in the art upon reading the foregoing description and which are not in the prior art.

1. A method for characterizing an application comprising:
at least one of:
monitoring installation of an application and recording information relating to at least one of file system, registry and database resources created or modified during installation of said application;
monitoring an application run and recording information relating to at least one of file system, registry, database and network resources accessed during run of said application; and
manually entering information relating to at least one of file system, registry, database and network resources employed by said application; and
filtering said information to provide filtered information and classifying said filtered information to obtain classified information.

2. A method for characterizing an application according to claim 1 and also comprising grouping said information into at least two of the following categories:
signature or bill of materials (BOM);
configuration information;
runtime information; and
instance parameters.

3. A method for characterizing an application according to claim 1 and wherein said classifying comprises classifying said filtered information into at least one of the following classifications based on significance:
installation specific significance;
performance significance;
localization significance;
security significance;
recovery significance;
high availability significance;
application startup-ability significance; and
functional significance.

4. A method for characterizing an application according to claim 1 and wherein at least one of said monitoring an application run, manually entering, filtering and classifying is repeated at least once.

5. A method for characterizing an application according to claim 1 and wherein said monitoring an application run and recording information also includes recording information relating to at least file system, registry and database resources created or modified during run of said application.

6. A method for characterizing an application according to claim 1 and also comprising generating application configuration definitions based on at least one of said filtered information and on classification thereof.

7. A method for characterizing an application according to claim 6 and wherein said method also comprises at least one of:
distributing said application configuration definitions to at least one agent;
collecting application configuration information from said at least one agent based on said application configuration definitions;
noting changes in said application configuration information defined by said application configuration definitions;
classifying said changes into at least one group based on criticality and significance in accordance with said application configuration definitions; and
acting based on said changes and said classification in accordance with said application configuration definitions.

8. A method for characterizing an application according to claim 7 and wherein said acting comprises at least one of:
sending an E-mail;
registering user alerts in at least one of an event log and a system log; and
sending a text message.

9. A method for characterizing an application according to claim 1 and wherein said filtering comprises employing user definable custom filters to filter said information.

10. A method for characterizing an application according to claim 6 and wherein said filtering comprises automatically filtering said information in accordance with said application configuration definitions.

11. A method for characterizing an application according to claim 1 and also comprising formatting future information presentation using said classified information.

12. A method for characterizing an application according to claim 1 and wherein said classifying comprises:
associating with each item of said filtered information a descriptor identifying a manner in which said item affects said application.

13. A method for characterizing an application according to claim 1 and wherein said information comprises information relating to configuration items having greater granularity than resources.

14. A method for characterizing an application according to claim 1 and wherein said classifying filtered information also includes referencing configuration items having greater granularity than resources.

15. A method for characterizing an application according to claim 1 and wherein said classifying also comprises at least one of classifying said filtered information based on criticality and classifying said filtered information into at least one group based on significance.

16. A method for characterizing an application according to claim 1 and wherein said classifying also comprises classifying said filtered information as to at least one of the extent and type of a result produced by a change in a given configuration item irrespective of a granularity of said given configuration item.

17. A method for characterizing an application according to claim 1 and wherein said method also comprises:
at least one of:
initiating monitoring installation of an application to begin recording information relating to at least one of file system, registry and database resources created or modified during installation of said application;
launching and carrying out said installation of said application;
monitoring said installation of said application and recording said information relating to resources created or modified during installation of said application;
terminating said monitoring said installation and recording;
initiating monitoring an application run to begin recording information relating to at least one of file system, registry, database and network resources accessed during run of said application;
launching and carrying out said application run;
monitoring said application run to begin recording said information relating to resources accessed during said run of said application;
terminating said monitoring said application run and recording;
manually entering information relating to at least one of file system, registry, database and network resources which information has not been recorded;
filtering said information to provide filtered information; and
classifying said filtered information into at least one group based on at least one of criticality and significance.

18. A system for characterizing an application comprising:
at least one of:
application installation monitoring functionality operative to monitor installation of an application and record information relating to at least one of file system, registry and database resources created or modified during installation of said application;
application run monitoring functionality operative to monitor an application run and record information relating to at least one of file system, registry, database and network resources accessed during run of said application; and
manual information input functionality operative to enable manual entering of information relating to at least file system, registry, database and network resources employed by said application; and
information filtering functionality operative to provide filtered information; and classification functionality operative to classify said filtered information into at least one group based on at least one of criticality and significance.

19. A system for characterizing an application according to claim 18 and wherein at least one of said application installation monitoring functionality and said application run monitoring functionality is also operative to group said information according to at least two of the following categories:
signature or bill of materials (BOM);
configuration information;
runtime information; and
instance parameters.

20. A system for characterizing an application according to claim 18 and wherein said classification functionality is also operative to classify said filtered information into at least one of the following classifications:
installation specific significance;
performance significance;
localization significance;
security significance;
recovery significance;
high availability significance;
application startup-ability significance; and
functional significance.

21. A system for characterizing an application according to claim 18 and wherein said application run monitoring functionality is also operative to record information relating to at least one of file system, registry and database resources created or modified during run of said application.

22. A system for characterizing an application according to claim 18 and wherein said system also comprises an application definitions assistant operative to generate application configuration definitions based on said filtered information and on classification thereof.

23. A system for characterizing an application according to claim 22 and wherein the system also comprises:
distribution functionality operative to distribute said application configuration definitions to at least one agent;
configuration information collection functionality operative to collect application configuration information from said at least one agent based on said application configuration definitions;
configuration information changes noting functionality operative to note changes in said application configuration information defined by said application configuration definitions;
change classification functionality operative to classify said changes into at least one group based on at least one of criticality and significance in accordance with said application configuration definitions; and
action functionality operative to take at least one action based on said changes and said classification thereof.

24. A system for characterizing an application according to claim 23 and wherein said at least one action comprises at least one of the following:
send an E-mail;
register at least one user alert in at least one of an event log and a system log; and
send a text message

25. A system for characterizing an application according to claim 18 and wherein said information filtering functionality is also operative to filter said information based on user definable custom filters.

26. A system for characterizing an application according to claim 22 and wherein said information filtering functionality is also operative to automatically filter said information in accordance with said application configuration definitions.

27. A system for characterizing an application according to claim 18 and wherein said system also comprises configuration management functionality operative to format future information presentation using said classified filtered information

28. A system for characterizing an application according to claim 18 and wherein said classification functionality is operative to classify said filtered information into at least one group based on at least one of criticality and significance.

29. A system for characterizing an application according to claim 18 and wherein said classification functionality is operative to classify said filtered information into at least one group based on at least one of criticality and significance by associating with each item of said filtered information a descriptor which identifies a manner in which said item affects said application.

30. A system for characterizing an application according to claim 18 and wherein at least one of said application installation monitoring functionality and said application run monitoring functionality is also operative to obtain information relating to at least one of file system, registry, database and network resources created or modified which information also relates to configuration items having greater granularity than resources.

31. A system for characterizing an application according to claim 18 and wherein said classification functionality is also operative to classify filtered information referencing configuration items having greater granularity than resources.

32. A system for characterizing an application according to claim 18 and wherein said classification functionality is also operative to classify said filtered information as to at least one of the extent and the type of result produced by change in a given configuration item irrespective of the granularity of said given configuration item.
